(19) United States
(12) Patent Application Publication
(10) Pub. No.: US 2009/0310365 A1
(43) Pub. Date: Dec. 17, 2009

(54) LIGHTING APPARATUS

(75) Inventor: Hiroaki ONISHI, Kyoto-shi (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO., LTD., Kyoto-shi (JP)

(21) Appl. No.: 12/485,438

(22) Filed: Jun. 16, 2009

(30) Foreign Application Priority Data
Jun. 17, 2008 (JP) 2008-157698

(51) Int. Cl. F21V 7/00; F21S 6/00

(52) U.S. Cl. 362/296.01; 362/257

(57) ABSTRACT

A lighting apparatus is used, for example, to illuminate a traffic space in which people is supposed to move about, typically walk back and forth. The lighting apparatus includes a light source unit which may be disposed in the traffic space, and a light guide provided with a light incident surface at an end and a light emitting portion at the other end. The light guide is elongated to extend from the light incident surface to the light emitting portion. The light incident surface is arranged to receive the light emitted from the light source unit. The light emitting portion is arranged to emit the inwardly guided light toward the traffic space.

### BACKGROUND OF THE INVENTION

1. Field of the Invention

The present invention relates to a lighting apparatus used indoors and outdoors.

2. Description of the Related Art

FIG. 17 illustrates an example of conventional lighting apparatus (see JP-A-2000-156113, for example). The lighting apparatus X illustrated in the figure is designed to illuminate an indoor space Sp in a room, for example. The lighting apparatus X is set on the ceiling C1 to illuminate the space Sp. The lighting apparatus X includes straight fluorescent lamps 91 as the light source.

With time, the fluorescent lamps 91 will age, becoming unduly dim or even unable to start at all when switched on. In such an instance, the user needs to replace the fluorescent lamps 91. However, since the lighting apparatus X is set on the ceiling C1, the user may not reach the fluorescent lamps 91 when simply standing on the floor F1. Thus, in replacing the fluorescent lamps 91, the user needs to fetch a stepladder or the like to step on. When a number of lighting apparatuses X are set on the ceiling C1, the replacement work with the use of a stepladder may become laborious since the same operation needs to be done repeatedly at different places.

### SUMMARY OF THE INVENTION

An object of the present invention, which is proposed under the circumstances described above, is to provide a lighting apparatus which facilitates the replacement of the light source.

According to the present invention, there is provided a lighting apparatus for illuminating an object space of a certain volume. The lighting apparatus includes: a light source unit; and a light guide provided with a light incident surface and a light emitting portion. The light guide is elongated to extend from the light incident surface to the light emitting portion. The light incident surface is arranged to receive light emitted from the light source unit, while the light emitting portion is arranged to emit light toward the object space.

Preferably, the light source unit may include at least one LED chip.

Preferably, the light emitting portion may include a reflective surface and an emitting surface, where the reflective surface is arranged to reflect light guided in a longitudinal direction and causing the reflected light to travel in a direction crossing the longitudinal direction, while the emitting surface is arranged to emit the reflected light.

Preferably, the light guide may include at least one dividing portion for separating the incident surface and the light emitting portion from each other.

Preferably, the object space may be a traffic space in which people are supposed to move about.

Preferably, the light emitting portion may be disposed outside of the traffic space, while the light source unit may be disposed in the traffic space.

Other features and advantages of the present invention will become more apparent from detailed description given below with reference to the accompanying drawings.

### BRIEF DESCRIPTION OF THE DRAWINGS

FIG. 1 is a front view, partially in section, illustrating a lighting apparatus according to a first embodiment of the present invention;

FIG. 2 is a sectional view illustrating a principal portion of the light source unit of the lighting apparatus illustrated in FIG. 1;

FIG. 3 is a sectional view illustrating a principal portion of the light emitting portion of the lighting apparatus illustrated in FIG. 1;

FIG. 4 is a perspective view illustrating a variation of the lighting apparatus according to the first embodiment of the present invention;

FIG. 5 is a perspective view illustrating a lighting apparatus according to a second embodiment of the present invention;

FIG. 6 is a perspective view illustrating a lighting apparatus according to a third embodiment of the present invention;

FIG. 7 is a perspective view illustrating a lighting apparatus according to a fourth embodiment of the present invention;

FIG. 8 is a perspective view illustrating a lighting apparatus according to a fifth embodiment of the present invention;

FIG. 9 is a sectional view taken along lines IX-IX in FIG. 8;

FIG. 10 is a perspective view illustrating a lighting apparatus according to a sixth embodiment of the present invention;

FIG. 11 is a sectional view taken along lines XI-XI in FIG. 10;

FIG. 12 is a perspective view illustrating an example of lighting unit of the lighting apparatus illustrated in FIG. 10;

FIG. 13 is a sectional view taken along lines XIII-XIII in FIG. 12;

FIG. 14 is a perspective view illustrating another example of lighting unit of the lighting apparatus illustrated in FIG. 10;

FIG. 15 is a perspective view illustrating another example of lighting unit of the lighting apparatus illustrated in FIG. 10;

FIG. 16 is a perspective view illustrating another example of lighting unit of the lighting apparatus illustrated in FIG. 10; and

FIG. 17 is a front view illustrating an example of conventional lighting apparatus.

### DETAILED DESCRIPTION OF THE PREFERRED EMBODIMENTS

Preferred embodiments of the present invention will be described below with reference to the accompanying drawings.

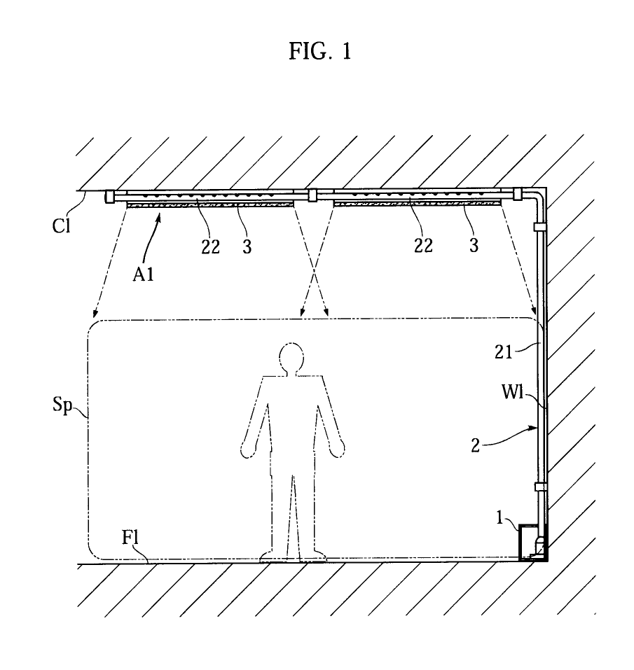

FIG. 1 illustrates a lighting apparatus according to a first embodiment of the present invention. The lighting apparatus A1 of this embodiment includes a light source unit 1, a light guide 2 and a cover 3. The lighting apparatus Al is designed to illuminate an indoor object space of a certain volume. In the illustrated example, the object space is a traffic space Sp (a room, a corridor, etc.) in which people are supposed to move about. The traffic space Sp may refer not only to such an indoor space but to an outdoor space, in which people can walk freely on the floor, road and so on. In this specification, regardless of indoors or outdoors, high positions which people cannot reach without using a height-adding tool such as a stepladder are not included in the traffic space Sp. In FIG. 1, the light source unit 1 and the cover 3 are illustrated as a sectional view.

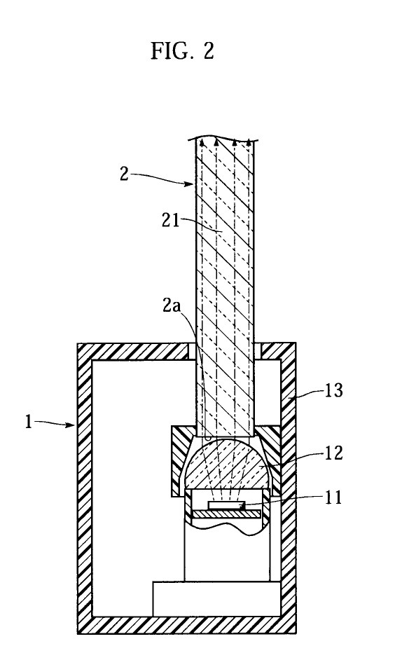

The light source unit 1 is a part to generate the light to be emitted from the lighting apparatus A1. In this embodiment, the light source unit 1 is placed in the traffic space Sp and in a corner of the floor F1. FIG. 2 is a sectional view illustrating the light source unit 1. As illustrated in the figure, the light source unit 1 includes an LED module 11, a lens 12 and a case 13. The LED module 11 is the light source of the lighting apparatus A1 and designed to emit e.g. white light. Specifically, the LED module 11 includes a plurality of LED chips for emitting red light, green light and blue light. By mixing the light from the LED chips, the LED module 11 emits white light. Unlike this, the LED module 11 may comprise an LED chip for emitting blue light and a fluorescent material which emits yellow light when excited by blue light.

The lens 12 is arranged to face the LED module 11 and enhances the directivity of the light emitted from the LED module 11. The case 13 accommodates the LED module 11 and the lens 12. In the light source unit 1, the case 13 is provided with a door (not shown), and the LED module 11 can be removed by opening the door.

The light guide 2 is made of e.g. a transparent acrylic resin. As illustrated in FIG. 1, the light guide 2 is entirely in the form of a bar, which may have a circular cross section. The light guide 2 includes an extending portion 21 and a plurality of light emitting portions 22. The extending portion 21 guides the light from the light source unit 1 to the light emitting portions 22, which are spaced away from the light source unit 1. In this embodiment, the extending portion 21 extends along the wall W1 from the light source unit 1 placed on the floor F1 to the ceiling C1. Typically, the length of the extending portion 21 may be greater than the user's height (in a range of 150-190 cm, for example, for an adult). As illustrated in FIG. 2, the lower end surface of the extending portion 21 serves as a light incident surface 2a through which the light from the light source unit 1 enters the light guide 2. The light incident surface 2a is arranged to face the light source unit 1.

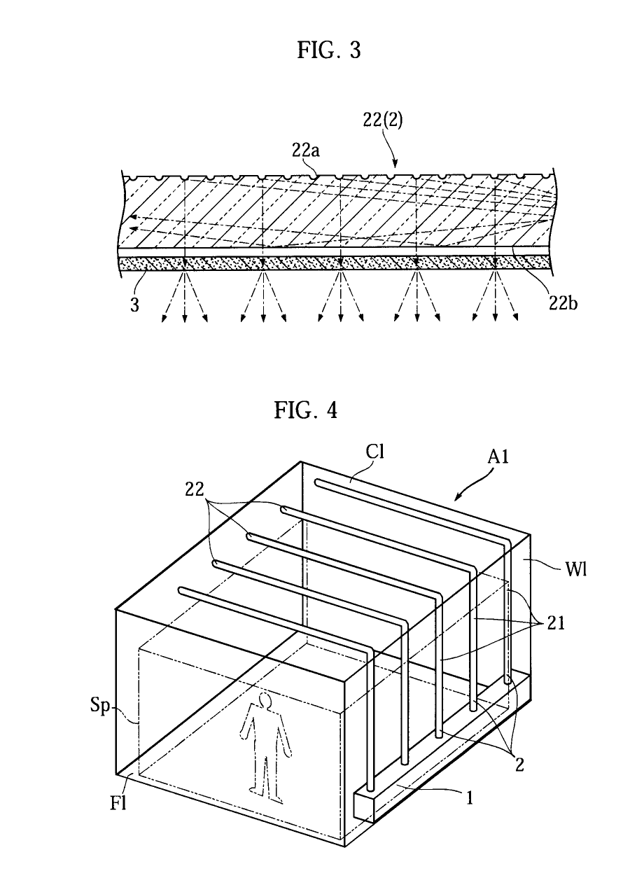

The light emitting portions 22 are utilized for emitting light toward the traffic space Sp. As illustrated in FIG. 1, the light emitting portions 22 are spaced away from the light source unit 1 via the elongated light guide 2. In this embodiment, a plurality of straight light emitting portions 22 are provided on the ceiling C1. As illustrated in FIG. 3, each of the light emitting portions 22 includes a reflective portion 22a and an emitting surface 22b. The light traveling within the light guide 2 in the longitudinal direction is reflected at the reflective portion 22a in a direction crossing the longitudinal direction. In this embodiment, the reflective portion 22a comprises a plurality of grooves spaced from each other in the longitudinal direction of the light guide 2. The grooves extend perpendicularly to the longitudinal direction of the light guide 2. The emitting surface 22b is positioned opposite the reflective portion 22a across the radial center of the light guide 2. The light reflected at the reflective portion 22a is emitted through the emitting surface 22b. In the example shown in FIG. 1, use is made of two light emitting portions 22 arranged in series, and each light emitting portion 22 is long enough to cover a little more than half the traffic space Sp for illumination.

The cover 3 is a semi-cylindrical part covering the light emitting portions 22. The cover 3 may be made of a milky-white light transmitting resin. By passing through the cover 3, the light emitted from the light emitting portions 22a is appropriately diffused. Thus, as illustrated in FIG. 1, the traffic space Sp is entirely illuminated by the lighting apparatus A1.

The advantages of the lighting apparatus A1 will be described below.

According to this embodiment, the light source unit 1 is placed in the traffic space Sp. Thus, the user can easily reach the light source unit 1 without using e.g. a stepladder. Thus, the replacement of the LED module 11 of the light source unit 1 is easy.

As compared with e.g. fluorescent lamps, the LED module 11 comprising an LED chip has a considerably longer life. Thus, the replacement of the LED module 11 does not need to be performed so frequently as when a fluorescent lamp is used, so that the burden on the operator is reduced.

In the lighting apparatus A1, heat is mainly produced at the LED module 11 of the light source unit 1 and is hardly produced at the light emitting portions 22 on the ceiling C1. Thus, a heat dissipation means may be necessary only at the light source unit 1. That is, it is not necessary to provide any heat dissipation means (which causes a significant increase in weight) at the light emitting portions 22 or nearby portions. This is advantageous in that the weight of the light guide 2 can be reduced at the portion supported by the ceiling C1.

FIGS. 4-16 illustrate other embodiments of the present invention. In these figures, the elements which are identical or similar to those of the foregoing embodiment are designated by the same reference signs as those used for the foregoing embodiment.

FIG. 4 illustrates a lighting apparatus as a variation of the first embodiment of the present invention. The lighting apparatus A1 of this variation includes a plurality of light guides 2. The light guides 2 are arranged in parallel to each other and extend along the wall W1 and the ceiling C1. This arrangement is suitable for uniformly illuminating the traffic space Sp.

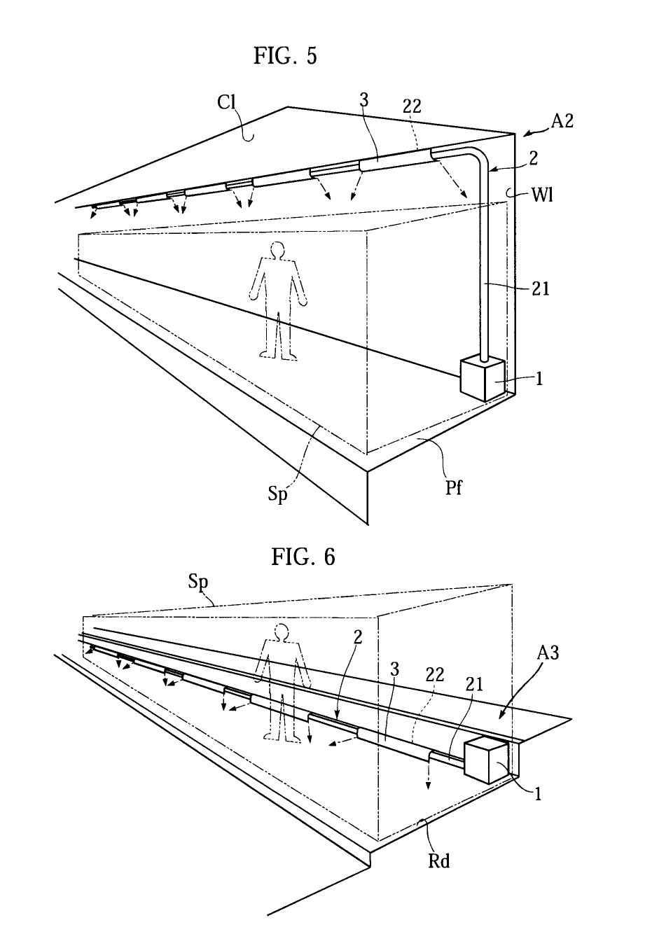

FIG. 5 illustrates a lighting apparatus according to a second embodiment of the present invention. The lighting apparatus A2 of this embodiment is designed to illuminate a traffic space Sp on a platform Pf of a station. The light source unit 1 is placed on the platform Pf. The light guide 2 includes an extending portion 21 extending upward along the wall W1. The light guide 2 further includes a plurality of light emitting portions 22 arranged along the ceiling C1. The light emitting portions 22 are equally spaced from each other in the longitudinal direction of the platform Pf.

According to this embodiment again, the replacement of the LED module 11 of the light source unit 1 is easy. Particularly, the traffic space Sp on the platform Pf is considerably long in one direction. Thus, of the plurality of the light emitting portions 22, the one that is farthest from the light source unit 1 may be several tens of meters away from the light source unit 1. However, the work for replacing the light source is only necessary for the light source unit 1. Thus, it is not necessary for the operator to walk from one end to the other of the platform Pf and replace the light source at many points of the platform Pf using e.g. a stepladder.

FIG. 6 illustrates a lighting apparatus according to a third embodiment of the present invention. The lighting apparatus A3 of this embodiment is designed to particularly illuminate a lower portion of the traffic space Sp on a road Rd. In this embodiment, the light source unit 1 is placed on the road Rd, and the light guide 2 extends along the road Rd. The light guide 2 includes a plurality of light emitting portions 22 which are equally spaced from each other along the road Rd.

According to this embodiment again, the replacement of the light source is easy. Generally, an apparatus for outdoor lighting needs to be protected from wind, rain, shock and so on by using any means. With the arrangement of the lighting apparatus A3, however, such protection may need to be mainly provided at the light source unit 1.

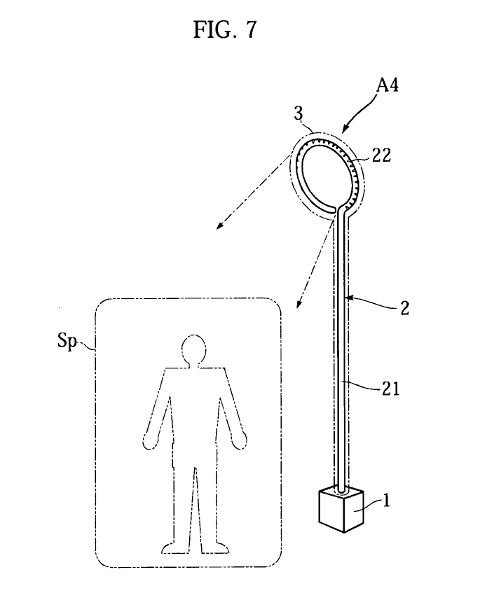

FIG. 7 illustrates a lighting apparatus according to a fourth embodiment of the present invention. The lighting apparatus A4 of this embodiment is designed as a lamp post to be set on a road. The light guide 2 includes an extending portion 21 standing vertically from the light source unit 1. The light guide 2 further includes a ring-shaped light emitting portion 22 connected to the upper end of the extending portion 21. The cover 3, which is indicated by phantom lines in the figure, entirely covers the light guide 2. Of the cover 3, the portion covering the light emitting portion 22 may be made of a milky-white light transmitting resin. Of the cover 3, the portion covering the extending portion 21 has a cylindrical shape suitable for supporting the light guide 2 and may be made of a resin. According to this embodiment again, the work for replacing the light source does not need to be performed at a high position, so that the work is easy.

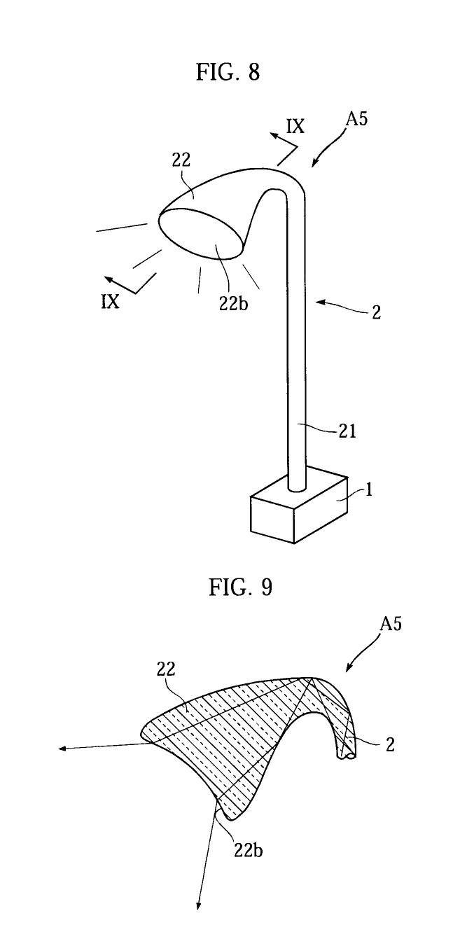

FIGS. 8 and 9 illustrate a lighting apparatus according to a fifth embodiment of the present invention. Similarly to the lighting apparatus A4, the lighting apparatus A5 of this embodiment is designed as a lamp post to be set on a road. The light guide 2 of this embodiment includes a light emitting portion 22 whose cross section becomes larger toward an end. The light emitting portion 22 includes a concave emitting surface 22b. With this arrangement, light is directed to a wide range through the emitting surface 22b.

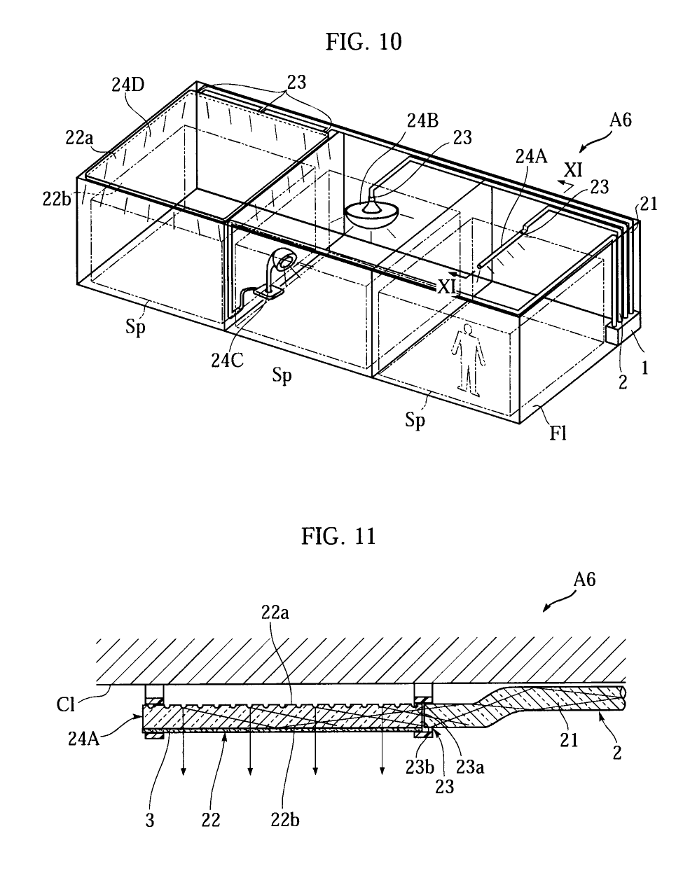

FIGS. 10-16 illustrate a lighting apparatus according to a sixth embodiment of the present invention. The lighting apparatus A6 includes a plurality of lighting units 24A, 24B, 24C and 24D and a common light source unit 1. Each of the lighting units 24A, 24B, 24C and 24D includes a light emitting portion 22 of a light guide 2. Each light guide 2 includes a dividing portion 23 for separating or detaching the lighting unit 24A, 24B, 24C or 24D. As shown in this example, the light source unit 1 may be disposed at a position outside of the traffic space Sp. Such a position, for example, may be outside of a room, corridor, etc. In this instance, an indoor switch, connected to the light source unit 1, may be provided at a readily reachable location on e.g. a wall. Alternatively, without providing such an indoor switch, use may be made of a remote controller for switching on and off the light source unit 1 from indoors.

As another example, the light source unit 1 may be disposed indoors, but not in a large traffic space in which people can freely move about. Specifically, the light source unit 1 may be disposed in a closed, special room or cabinet, in which other equipments such as an electricity meter, a gas meter and a water heater may be provided together. To accommodate the light source unit 1 (and perhaps together with the above-noted kinds of equipment), the special room does not need to be large enough to allow free movement of a person, but only permits the user easy access (that is, without using any stepladder) to the light source unit 1 for replacement or maintenance of the LED module 11. Such a closed space can confine the heat generated from the operation of the light source unit 1. Advantageously, such heat may be used, at least partially, for boiling water, air conditioning, or the generation of electricity, for example.

As illustrated in FIG. 11, each light guide 2 is divided at the dividing portion 23 and includes a pair of mutually facing surfaces 23a and 23b. The facing surface 23a is fixed to the ceiling C1. Of the light guide 2, the portion between the dividing portion 23 and an end which is farther from the light source unit 1 constitutes a structural part of the lighting unit. In the lighting unit 24A, the light entering through the facing surface 23b is reflected at the reflective portion 22a and then emitted from the emitting surface 22b. The lighting unit 24A includes a cover 3 for diffusing and transmitting the light emitted from the emitting surface 22b. The entirety of the lighting unit 24A is in the form of a straight bar similar to a straight fluorescent lamp. The color of the light to be emitted can be changed to e.g. daylight color, neutral, white, warm white or lamp color by replacing the lighting unit 24A with another lighting unit provided with a cover 3 of a different color.

The color of the light to be emitted can be changed also by replacing the LED module 11 of the light source unit 1 instead of replacing the lighting unit 24A. Further, when an LED module 11 which is capable of individually controlling the brightness of red light, green light and blue light is employed, the lighting unit can emit various colors of light.

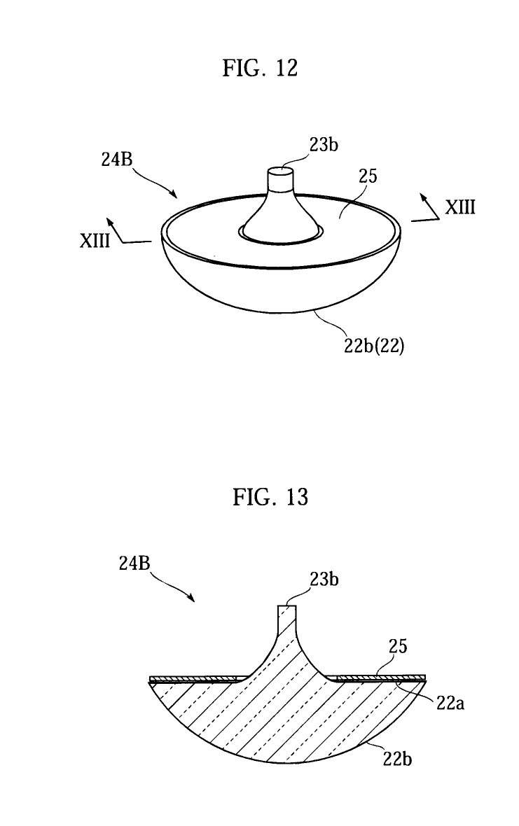

FIGS. 12 and 13 illustrate the lighting unit 24B. The lighting unit 24B comprises a straight portion including a facing surface 23b at the end, a flared portion whose diameter increases as proceeding away from the straight portion, and an umbrella-shaped portion connected to the flared portion. The lighting unit 24B has an appearance similar to that of a fluorescent lamp lighting apparatus to be set in e.g. a dining room. The upper surface of the umbrella-shaped portion serves as a reflective portion 22a. A reflector 25 is provided on the reflective portion 22a. The lower surface of the umbrella-shaped portion serves as an emitting surface 22b.

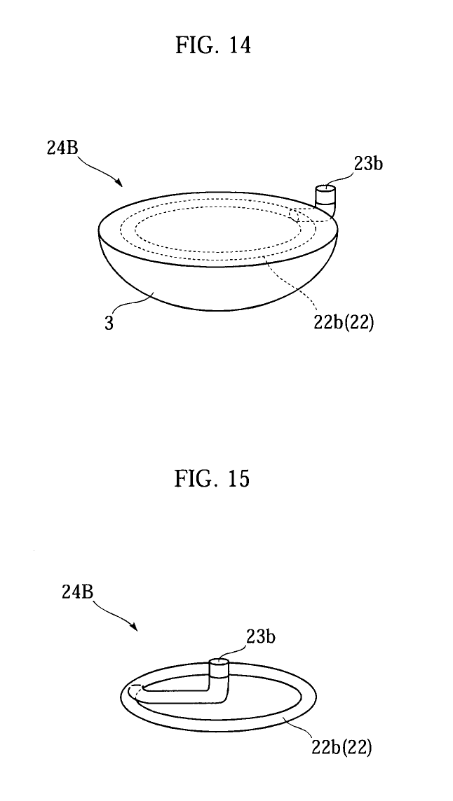

FIGS. 14 and 15 illustrate variations of the lighting unit 24B. The lighting unit 24B illustrated in FIG. 14 includes an annular portion connected to the facing surface 23b. The surface of the annular portion serves as an emitting surface 22b. The light emitted from the emitting surface 22b passes through the cover 3 while diffusing. The lighting unit 24B illustrated in FIG. 15 also includes an annular portion connected to the facing surface 23b. The lighting units 24B illustrated in these figures can be replaced with the lighting unit 24B of FIG. 10 for use.

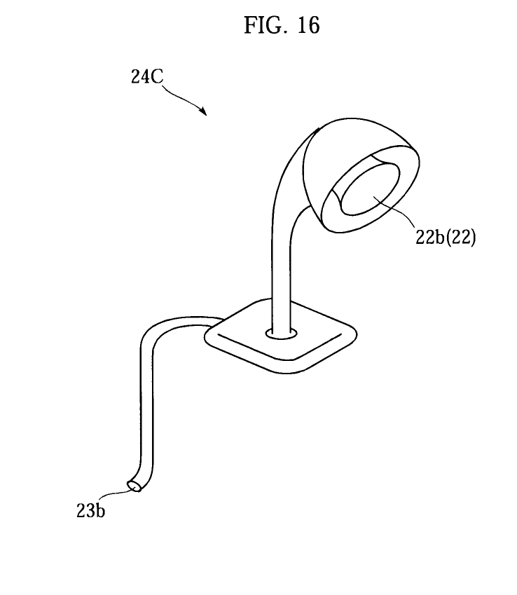

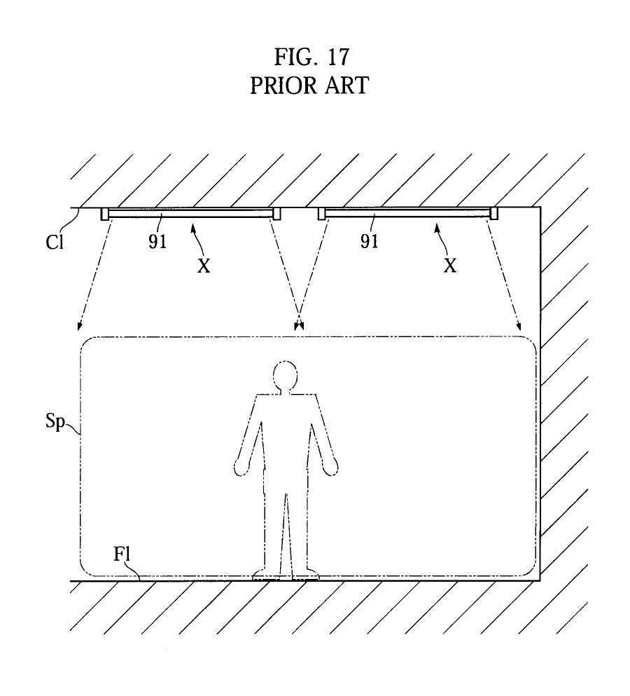

FIG. 16 illustrates the lighting unit 24C. The lighting unit 24C has an appearance similar to that of a fluorescent desk lamp to be set on e.g. a desk. The lighting unit 24C includes a tubular portion extending from the facing surface 23B. The tubular portion is made of e.g. a flexible transparent resin.

The lighting unit 24D illustrated in FIG. 11 is entirely in the form of a rectangular plate. The lighting unit 24D includes three facing surfaces (not shown), a reflective portion 22a and an emitting surface 22b. Light enters the lighting unit 24D through three dividing portions 23. The light is reflected by the reflective portion 22a and then emitted from the emitting surface 22b. The lighting unit 24D is suitable for uniformly illuminating the entirety of the traffic space Sp.

In the lighting apparatus A6, the facing surface 23a fixed to each room functions similarly to a socket for the household power supply. Thus, various lighting units can be incorporated in the lighting apparatus A6 as long as the lighting unit has a facing surface similar to those of the lighting units 24A, 24B and 24C. The lighting units 24A, 24B and 24C do not need to receive power supply and are not heated. Thus, lighting units having various shapes and relatively small weight can be designed.

The lighting apparatus according to the present invention is not limited to the foregoing embodiments. For instance, the lighting apparatus may be used for illuminating a space which ordinary people never go into. Examples of such spaces are in a cage of fierce animals, an unmanned laboratory, and so forth. In such a case, the light emitting portion may be provided in the space to be illuminated, while the light source unit may be provided outside of the space so as to permit the user easy and safe access to the LED module in the light source unit.

The light guide 2 may not be circular in cross section but may be rectangular. The cross sectional shape of the light guide 2 may not be uniform along the entire length. The reflective portion 22a does not necessarily comprise a plurality of grooves. For instance, the reflective portion 22a may be provided by surface roughening or a reflective film.

1. A lighting apparatus for illuminating an object space, the lighting apparatus comprising:
a light source unit; and
a light guide provided with a light incident surface and a light emitting portion, the light guide extending from the light incident surface to the light emitting portion, the light incident surface being arranged to receive light emitted from the light source unit, the light emitting portion being arranged to emit light toward the object space.

2. The lighting apparatus according to claim 1, wherein the light source unit includes an LED chip.

3. The lighting apparatus according to claim 1, wherein the light emitting portion includes a reflective surface and an emitting surface, the reflective surface being arranged to reflect light guided in a longitudinal direction and causing the reflected light to travel in a direction crossing the longitudinal direction, the emitting surface being arranged to emit the reflected light.

4. The lighting apparatus according to claim 1, wherein the light guide includes a dividing portion for separating the incident surface and the light emitting portion from each other.

5. The lighting apparatus according to claim 1, wherein the object space is a traffic space in which people are supposed to move about.

6. The lighting apparatus according to claim 1, wherein the light emitting portion is disposed outside of the traffic space, and the light source unit is disposed in the traffic space.
